(19) United States
(12) Patent Application Publication
(10) Pub. No.: US 2024/0360867 A1
(43) Pub. Date: Oct. 31, 2024

(54) CONNECTING ROD CONTINUOUSLY ADJUSTABLE IN LENGTH AND METHOD FOR FITTING THE ADJUSTABLE CONNECTING ROD

(71) Applicant: AIRBUS OPERATIONS (S.A.S.), Toulouse (FR)

(72) Inventors: Benoît PEREZ, Toulouse (FR); Vincent MAZARS, Toulouse (FR)

(21) Appl. No.: 18/647,874

(22) Filed: Apr. 26, 2024

(30) Foreign Application Priority Data
Apr. 27, 2023 (FR) 2304256

(51) Int. Cl. F16C 7/06

(52) U.S. Cl. CPC F16C 7/06

(57) ABSTRACT

An adjustable connecting rod is disclosed including an adjustment device for adjusting the length of the adjustable connecting rod and a connecting rod body, the adjustment device includes at least one yoke for fixing the adjustable connecting rod to an element and an intermediate part linking the yoke to the connecting rod body between a pivot link and a helical link. The combination of the pivot link and of the helical link implemented by the intermediate part allows the length of the adjustable connecting rod to be adjusted continuously.

### CROSS REFERENCE TO RELATED APPLICATION

This application claims priority to French Application Number FR 2304256, filed Apr. 27, 2023, the entire contents of which is hereby incorporated by reference.

### BACKGROUND

The present invention relates to a connecting rod that is continuously adjustable in length and a method for mounting the adjustable connecting rod.

A connecting rod corresponds to an elongate part, such as a bar, forming an articulated or non-articulated link between two elements. In order to fix the connecting rod to the two elements, it is necessary for the length of the connecting rod to be matched to the distance between the two elements. There are already adjustable connecting rods that allow their length to be adjusted in order to match it to said distance between the two elements. These adjustable connecting rods have a yoke linked to a connecting rod body by screwing of a threaded rod into a bore situated at one end of the connecting rod body. Now, in order to adjust the length of the yoke for it to be able to be fixed to the element for which it is intended, the threaded rod must turn by halves of turns in order for the yoke to be aligned with said element. That leads to an adjustment which is not continuous. Indeed, the adjustment of the length of the connecting rod is made by discrete steps which correspond to a value which is a multiple of the half of the screw pitch of the threaded rod. The adjustment of the length of the connecting rod is not therefore satisfactory. Moreover, an adjustment of such a connecting rod is tedious. Indeed, the connecting rod body must be misaligned with respect to the two elements to be able to make the halves of turns of the threaded rod.

There are also connecting rods that are continuously adjustable. However, these connecting rods are complex, costly and cannot be manufactured by conventional methods.

The connecting rods that are adjustable in length which currently exist are not fully satisfactory.

### SUMMARY

The present disclosure encompasses to mitigate the drawbacks of the existing adjustable connecting rods.

The present disclosure is directed toward a connecting rod that is adjustable in length extending along a longitudinal axis comprising:
an adjustment device configured to adjust the length of the adjustable connecting rod and articulate the adjustable connecting rod to a first element,
a connecting rod body having a first end comprising the adjustment device and a second end intended to link the adjustable connecting rod to a second element.

According to an exemplary embodiment, the adjustment device comprises at least one fixing yoke intended to fix the adjustable connecting rod to the first element and an intermediate part linking the yoke to the connecting rod body between a pivot link and a helical link, the helical link being configured to allow a translation of the yoke along a pivot axis parallel to the longitudinal axis of the adjustable connecting rod when the intermediate part is rotated by a user about the pivot axis, the pivot link being configured to allow an angular position of the yoke about the pivot axis to be maintained when the intermediate part is rotated about the pivot axis.

Thus, by virtue of the combination of the helical link moved by a user using the intermediate part and the pivot link, the length of the adjustable connecting rod can be adjusted continuously while maintaining an angular position of the yoke during the movement of the helical link.

Furthermore, the adjustment device comprises a locking device configured to block the rotation of the intermediate part with respect to the connecting rod body after the yoke has reached a desired position allowing the yoke to be fixed to the first element.

According to an exemplary embodiment, the pivot link links the intermediate part to the connecting rod body and the helical link links the intermediate part to the yoke.

According an exemplary embodiment, the yoke comprises a threaded rod having a longitudinal axis coinciding with the pivot axis, the intermediate part having a generally cylindrical form having an axis of revolution coinciding with the pivot axis, the intermediate part further having a tapped through-bore, the tapped through-bore having an axis of revolution coinciding with the pivot axis, the threaded rod of the yoke being screwed into the tapped through-bore of the intermediate part to form the helical link, the connecting rod body having a smooth bore having an axis of revolution coinciding with the pivot axis, the smooth bore having a first end emerging on the first end of the connecting rod body, the intermediate part having a smooth outer surface, the intermediate part being inserted into the smooth bore to form the pivot link, the adjustment device further comprising a blocking device configured to block the intermediate part in translation parallel to the pivot axis, a rotation of the intermediate part with respect to the connecting rod body by a user being able to drive a translation of the yoke along the pivot axis when the yoke is blocked in rotation about the pivot axis by the user.

According to an exemplary embodiment, the pivot link links the intermediate part to the yoke and the helical link links the intermediate part to the connecting rod body.

According an exemplary embodiment, the intermediate part corresponds to a threaded rod having an axis of revolution coinciding with the pivot axis, the yoke comprising an opening having a center coinciding with the pivot axis, the threaded rod having a first end passing into the opening of the yoke to form the pivot link, the connecting rod body having a tapped bore having an axis of revolution coinciding with the pivot axis, the threaded rod having a second end screwed into the tapped bore to form the helical link, the adjustment device further comprising a blocking device configured to block the yoke in translation parallel to the pivot axis along the threaded rod, a rotation of the threaded rod with respect to the connecting rod body by a user being able to drive a translation of the threaded rod and of the yoke along the pivot axis when the yoke is blocked in rotation about the pivot axis by the user.

The present disclosure also relates to a method for fitting the connecting rod to a first element and to a second element.

According to an exemplary embodiment, the method comprises the following steps:
a step of alignment of the adjustable connecting rod between the second element and the first element,
a step of alignment of the yoke in a desired angular position about the pivot axis with respect to the first element,
a step of rotation of the intermediate part of the adjustment device by a movement of the helical link, the intermediate part being rotated with respect to the connecting rod body by a user to drive a translation of the yoke parallel to the pivot axis until the yoke reaches a desired position allowing the yoke to be fixed to the first element, the pivot link being moved by the rotation of the intermediate part while the angular position of the yoke is maintained,
a step of fixing of the yoke to the first element.

According to an exemplary embodiment, the method comprises a step of fixing the second end of the connecting rod body to the second element.

According to an exemplary embodiment, the method further comprises a step of locking by the locking device to block the rotation of the intermediate part with respect to the connecting rod body after the yoke has reached a desired position allowing the yoke to be fixed to the first element.

### BRIEF DESCRIPTION OF THE DRAWINGS

The attached Figures will give a good understanding as to how the invention can be produced. In these Figures, identical references designate similar elements.

FIG. 1 is a schematic partial profile cutaway of an adjustment device of the adjustable connecting rod according to an exemplary embodiment.

FIG. 2 is a schematic view of the adjustable connecting rod fixed to the first and second elements.

FIG. 3 is a schematic illustration of the method for fitting the adjustable connecting rod.

FIG. 4 is a partial perspective cutaway of the adjustable connecting rod according to an exemplary embodiment.

FIG. 5 is a partial perspective cutaway of the adjustable connecting rod according to an exemplary embodiment.

FIG. 6 is a partial perspective cutaway of the adjustable connecting rod according to an exemplary embodiment.

FIG. 7 is a longitudinal cross-section of the adjustable connecting rod according to an exemplary embodiment.

### DETAILED DESCRIPTION

Some embodiments will now be described with reference to the Figures.

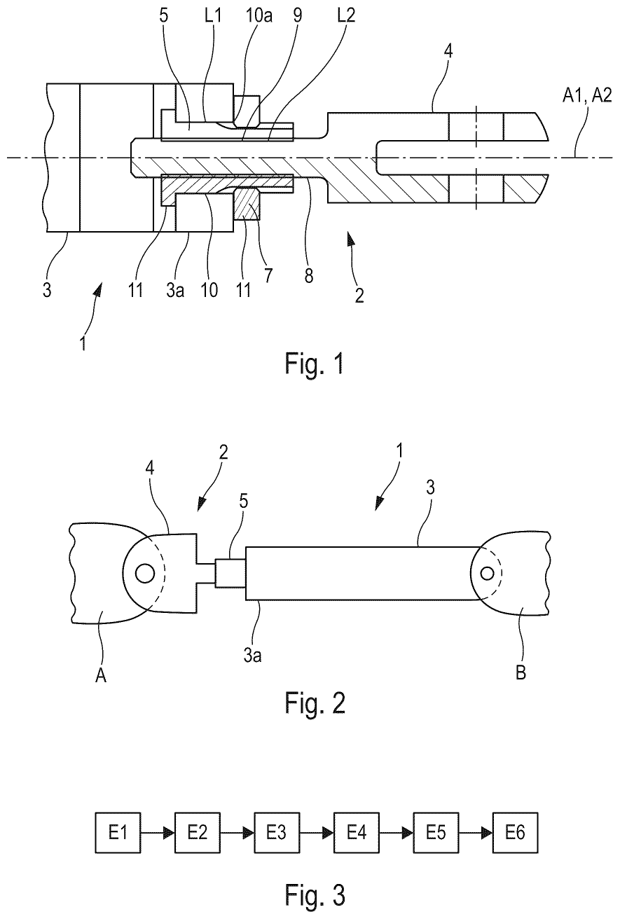

FIGS. 1 and 4-7 illustrate an adjustable connecting rod 1. The adjustable connecting rod 1 is adjustable in length. It extends along a longitudinal axis A1.

The adjustable connecting rod 1 comprises an adjustment device 2 configured to adjust the length of the adjustable connecting rod 1 and to articulate the adjustable connecting rod 1 to a first element A.

The adjustable connecting rod 1 also comprises a connecting rod body 3 having a first end 3a comprising the adjustment device 2 and a second end 3b intended to link the adjustable connecting rod 1 to a second element B.

The second end 3b is intended to link the adjustable connecting rod 1 to the second element B according to two configurations.

According to the first configuration of the adjustable connecting rod 1, the second end 3b is intended to articulate the adjustable connecting rod 1 to the second element B.

According to the second configuration of the adjustable connecting rod 1, the second end 3b is securely linked to the second element B. Thus, by way of example, the second element B can comprise the connecting rod body 3.

The first element A and the second element B can correspond to two distinct systems which are intended to be linked together by the adjustable connecting rod 1 (FIG. 2).

As represented in FIG. 1 and FIG. 7, the adjustment device 2 comprises at least one fixing yoke 4 intended to fix the adjustable connecting rod 1 to the first element A and an intermediate part 5, 6 linking the yoke 4 to the connecting rod body 3 between a pivot link L1 and a helical link L2.

The helical link L2 is configured to allow a translation of the yoke 4 along a pivot axis A2 parallel to the longitudinal axis A1 of the adjustable connecting rod 1 when the intermediate part 5, 6 is rotated by a user about the pivot axis A2.

The pivot link L1 is configured to allow an angular position of the yoke 4 about the pivot axis A2 to be maintained when the intermediate part 5, 6 is rotated about the pivot axis A2.

For example, the user can maintain the angular position of the yoke 4 in order for it to remain aligned with the first element A when the intermediate part 5, 6 is rotated about the pivot axis A2.

The adjustment device 2 can also comprise a locking device 7 configured to block the rotation of the intermediate part 5, 6 with respect to the connecting rod body 3 after the yoke 4 has reached a desired position allowing the yoke 4 to be fixed to the first element A.

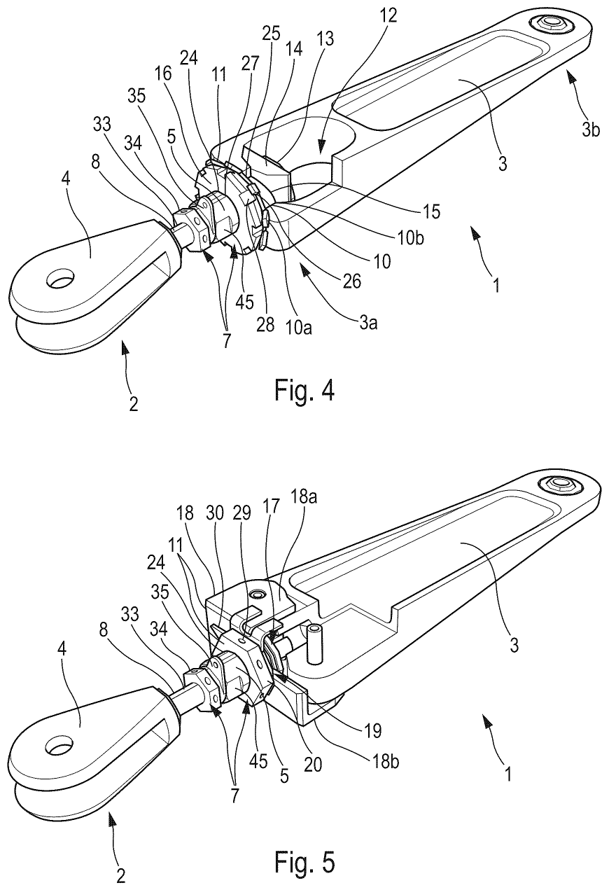

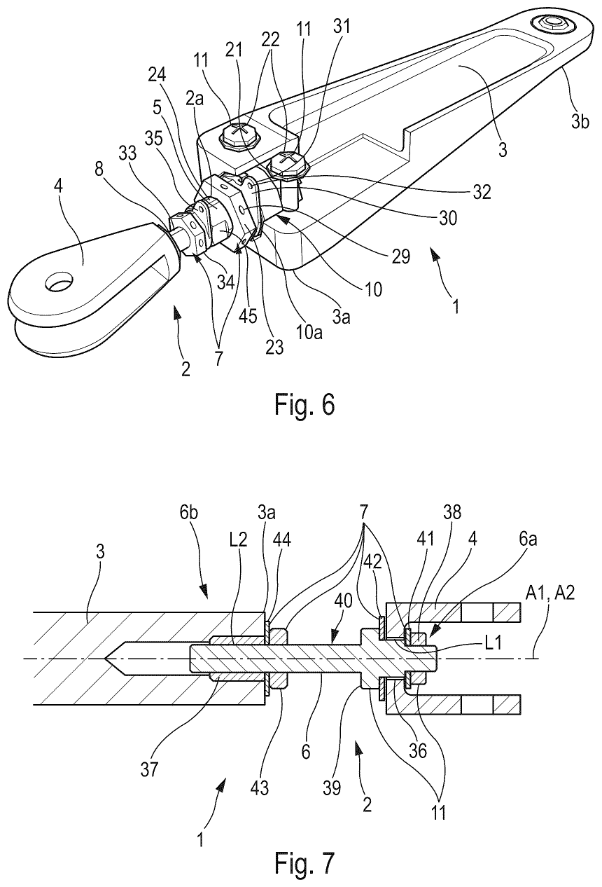

According to the exemplary embodiment shown in FIG. 1, FIG. 4, FIG. 5, and FIG. 6, the pivot link L1 links the intermediate part 5 to the connecting rod body 3.

In addition, the helical link L2 links the intermediate part 5 to the yoke 4.

The yoke 4 comprises a threaded rod 8 having a longitudinal axis coinciding with the pivot axis A2. The intermediate part 5 has a generally cylindrical form having an axis of revolution coinciding with the pivot axis A2. The intermediate part 5 further includes a tapped through-bore 9. The tapped through-bore 9 has an axis of revolution coinciding with the pivot axis A2. The threaded rod 8 of the yoke 4 is screwed into the tapped through-bore 9 of the intermediate part 5 to form the helical link L2.

Furthermore, in this embodiment, the connecting rod body 3 comprises a smooth bore 10 having an axis of revolution coinciding with the pivot axis A2. The smooth bore 10 has a first end 10a emerging on the first end 3a of the connecting rod body 3. The intermediate part 5 has a smooth outer surface. The intermediate part 5 is inserted into the smooth bore 10 to form the pivot link L1. A rotation of the intermediate part 5 with respect to the connecting rod body 3 by a user may be able to drive a translation of the yoke 4 along the pivot axis A2 when the yoke 4 is blocked in rotation about the pivot axis A2 by the user.

In this embodiment, the adjustment device 2 further comprises a blocking device 11 configured to block the intermediate part 5 in translation parallel to the pivot axis A2. This blocking device makes it possible to keep the pivot link L1 between the intermediate part 5 and the connecting rod body 30a in order for it not to become a sliding pivot link. The blocking device 11 can comprise the locking device 7, as represented in FIG. 1.

FIG. 4 represents an exemplary embodiment of the adjustable connecting rod 1.

In this exemplary embodiment, the connecting rod body 3 comprises an opening 12 passing through the connecting rod body 3 at right angles to the pivot axis A2. The smooth bore 10 has a second end 10b emerging in the opening 12. Thus, the smooth bore 10 is a through-bore extending between, on the one hand, its first end 10a emerging on the first end 3a of the connecting rod body 3 and, on the other hand, its second end 10b emerging in the opening 12.

The intermediate part 5 has a circumferential shoulder 13 on the outer surface of the intermediate part 5. The intermediate part 5 is placed in the smooth bore 10 so that the circumferential shoulder 13 is situated in the opening 12.

In this first variant, the blocking device 11 comprises a plate 14 and a lock nut 16. The plate 14 is configured to block the intermediate part 5 in translation toward the first end 3a of the connecting rod body 3. The plate 14 has an orifice 15 through which the intermediate part 5 is inserted. The plate 14 is disposed between the second end 10b of the smooth bore 10 and the circumferential shoulder 13. In order for the plate 14 to retain the intermediate part 5, the orifice 15 of the plate 14 has a diameter strictly less than the diameter of the circumferential shoulder 13. The plate 14 can take different forms. The plate 14 has at least one surface which is adapted in order for it to closely follow the inner surface of the opening 12 against which the plate 14 is pressed. In FIG. 4, the plate 14 has a semi-cylindrical form having a curved surface and a flat surface. The curved surface is adapted in order for it to closely follow the inner surface of the opening 12 against which the plate 14 is pressed. The flat surface is adapted to receive the circumferential shoulder 13 of the intermediate part 5.

The lock nut 16 is configured to block the intermediate part 5 in translation toward the second end 3b of the connecting rod body 3. The lock nut 16 is screwed to a threaded portion on the outer surface of the intermediate part 5 against the first end 3a of the connecting rod body 3.

In this first variant, the intermediate part 5 can comprise a longitudinal groove 24. The lock nut 16 can correspond to a notched nut.

Advantageously, the locking device 7 comprises a lock washer 25 assembled with the intermediate part 5 between the lock nut 16 and the first end 10a of the smooth bore 10. The lock washer 25 comprises external tongues 26 extending away from the lock washer 25 and an internal tooth 27 that is inserted into the longitudinal groove 24 of the intermediate part 5. The rotation of the intermediate part 5 with respect to the connecting rod body 3 is blocked by pressing the lock washer 25 against the first end 10a of the smooth bore 10 by screwing the lock nut 16 to the threaded portion of the intermediate part 5 toward the connecting rod body 3 and by folding the tongues 26 of the lock washer 25 into notches 28 of the lock nut 16.

FIG. 5 represents an exemplary embodiment of the adjustable connecting rod 1. In this embodiment, the intermediate part 5 has a circumferential shoulder 17 on its outer surface.

In this second variant, the blocking device 11 comprises a U-shaped part 18 and a lock nut 20. The U-shaped part 18 is inserted between the circumferential shoulder 17 and the lock nut 20.

The U-shaped part 18 is configured to block the intermediate part 5 in translation toward the first end 3a of the connecting rod body 3. The U-shaped part 18 has a U-shaped profile having two parallel faces 18a, 18b. The two faces 18a, 18b correspond to the two free ends of the U which is the form of the profile of the U-shaped part. The two faces 18a, 18b of the U-shaped part 18 are fixed to the first end 3a of the connecting rod body 3. The free ends of the U are directed toward the second end 3b of the connecting rod body 3. The U-shaped part 18 has an opening 19 through which the intermediate part 5 is inserted. The circumferential shoulder 17 is situated between the U-shaped part 18 and the first end 3a of the connecting rod body 3. The opening 19 of the U-shaped part 18 has a diameter strictly less than the diameter of the circumferential shoulder 17 of the intermediate part 5, in order for the U-shaped part 18 to retain the intermediate part 5.

The lock nut 20 is configured to block the intermediate part 5 in translation toward the second end 3b of the connecting rod body 3. The lock nut 20 is screwed to a threaded portion on the outer surface of the intermediate part 5 against the U-shaped part 18.

In this embodiment, the intermediate part 5 can comprise a longitudinal groove 24. The lock nut 20 can correspond to a first lock wire nut with having lock wire holes 29.

Advantageously, the locking device 11 comprises a first lock wire washer 30 assembled with the intermediate part 5 between the lock wire first nut 20 and the U-shaped part 18. The first lock wire washer 30 comprises a tongue having a lock wire hole and an internal tooth that is inserted into the longitudinal groove 24 of the intermediate part 5.

The rotation of the intermediate part 5 with respect to the connecting rod body 3 can be blocked by pressing the first lock wire washer 30 against the U-shaped part 18 by screwing of the first lock wire nut 20 and by a wire passing through lock wire holes 29 of the first lock wire nut 20 and through the lock wire hole of the first lock wire washer.

FIG. 6 represents an exemplary embodiment of the adjustable connecting rod 1.

In this embodiment, the intermediate part 5 has a circumferential groove 21 on its outer surface. The blocking device 11 comprises at least one retaining rod 22. The retaining rod or rods 22 pass at least partially through the connecting rod body 3 at right angles to the pivot axis A2. The retaining rod or rods 22 are inserted partially into the circumferential groove 21 of the intermediate part 5 parallel to the circumferential groove 21. Thus, the retaining rod or rods 22 block the translation of the intermediate part 5 parallel to the pivot axis A2. The blocking device 11 may include two retaining rods 22 inserted into the connecting rod body 3 on either side of the intermediate part 5. Moreover, the retaining rod or rods 22 can comprise an outer surface having a smooth portion and a threaded portion. The threaded portion can be situated at their free end. Thus, the retaining rod or rods 22 are screwed into the connecting rod body 3 at their free end at the threaded portion. The smooth portion of the retaining rod or rods 22 is then received partially in the circumferential groove 21.

In this embodiment, the intermediate part 5 can comprise a longitudinal groove 24. Advantageously, the locking device 11 comprises a first lock wire nut 23 screwed to a threaded section of the intermediate part 5 and a first lock wire washer 30 assembled with the intermediate part 5 between the first lock wire nut 23 and the first end 10a of the smooth bore 10. The first lock wire washer 30 comprises a tongue 31 having a lock wire hole 32 and an internal tooth that is inserted into the longitudinal groove 24 of the intermediate part 5.

The rotation of the intermediate part 5 with respect to the connecting rod body 3 can be blocked by pressing the first lock wire washer 30 against the first end 10a of the smooth bore 10 by screwing of the first lock wire nut 23 and by a wire passing through lock wire holes 32 of the first lock wire nut 23 and through the lock wire hole 32 of the first lock wire washer 30.

The locking device 11 in FIGS. 4, 5, and 6 can further comprise a lock nut 34 screwed to the threaded rod 8 of the yoke 4 to block the translation of the threaded rod 8 of the yoke 4 with respect to the intermediate part 5. For example, the lock nut 16 corresponds to a second lock wire nut. The threaded rod 8 of the yoke 4 comprises a longitudinal groove 33.

The locking device 11 can also comprise a second lock wire washer 35 assembled with the threaded rod 8 of the yoke 4 between the second lock wire nut 16 and the intermediate part 5. The second lock wire washer 35 comprises a tongue having a lock wire hole and an internal tooth that is inserted into the longitudinal groove 33 of the threaded rod 8 of the yoke 4. The rotation of the intermediate part 5 with respect to the connecting rod body 3 is blocked by pressing the second lock wire washer 35 against the intermediate part 5 by screwing of the second lock wire nut 16 and by the passage of a wire through the lock wire holes of the second lock wire nut 16 and through the lock wire hole of the second lock wire washer 35.

Furthermore, for each of exemplary embodiments, the intermediate part 5 can comprise at least two flats 45 on its outer surface, disposed at 180° with respect to one another. These flats 45 allow the user to actuate, manually or using a tool, the intermediate part 5 for it to enter into rotation about the pivot axis A2. The tool can correspond to an open-end adjustable wrench, a monkey wrench, a combination wrench or any other kind of suitable tool.

According to an exemplary embodiment shown in FIG. 7, the pivot link L1 links the intermediate part 6 to the yoke 4. Furthermore, the helical link L2 links the intermediate part 6 to the connecting rod body 3.

According to an exemplary embodiment, the intermediate part 6 corresponds to a threaded rod 6 having an axis of revolution coinciding with the pivot axis A2. The yoke 4 comprises an opening 36 having a center coinciding with the pivot axis A2. The threaded rod 6 has a first end 6a passing into the opening 36 of the yoke 4 to form the pivot link L1.

The connecting rod body 3 has a tapped bore 37 having an axis of revolution coinciding with the pivot axis A2. The threaded rod 6 has a second end 6b screwed into the tapped bore 37 to form the helical link L2. The tapped bore 37 can correspond to a smooth bore into which a tapped sleeve is inserted.

In this exemplary embodiment, the adjustment device 2 further comprises a blocking device 11 configured to block the yoke 4 in translation parallel to the pivot axis A2 along the threaded rod 6.

A rotation of the threaded rod 6 with respect to the connecting rod body 3 by a user is able to drive a translation of the threaded rod 6 and of the yoke 4 along the pivot axis A2 when the yoke 4 is blocked in rotation about the pivot axis A2 by the user.

In this exemplary embodiment, the blocking device 11 comprises a first lock nut 38 and a circumferential shoulder 39.

The first lock nut 38 is screwed to the first end 6a of the threaded rod 6 such that the yoke 4 is blocked in translation toward the first end 6a of the threaded rod 6. The circumferential shoulder 39 corresponds to a circumferential shoulder of the threaded rod 6 such that the yoke 4 is blocked in translation toward the second end 6b of the threaded rod 6.

In this exemplary embodiment, the threaded rod 6 comprises a longitudinal groove 40. The first lock nut 38 corresponds to a notched nut. The locking device comprises a first lock washer 41, a second lock washer 42, a third lock washer 44 and a second lock nut 43.

The first lock washer 41 is fitted to the threaded rod 6 between the yoke 4 and the notched nut 38. The first lock washer 41 comprises external tongues extending away from the first lock washer 41 and an internal tooth that is inserted into the longitudinal groove 40 of the threaded rod 6.

The second lock washer 42 is fitted to the threaded rod 6 between the yoke 4 and the circumferential shoulder 39. The second lock washer 42 comprises external tongues extending away from the second lock washer 42 and an internal tooth that is inserted into the longitudinal groove 40 of the threaded rod 6.

The second lock nut 43 is screwed to the second end 6b of the threaded rod 6. The third lock washer 44 is fitted to the threaded rod 6 between the second lock nut 43 and the first end 3b of the connecting rod body 3. The third lock washer 44 comprises external tongues extending away from the third lock washer 44 and an internal tooth that is inserted into the longitudinal groove 40 of the threaded rod 6. The rotation of the threaded rod 6 with respect to the connecting rod body 3 is blocked by screwing the notched nut 38 against the first lock washer 41 pressed against the yoke 4 and by folding the tongues of the first lock washer 41 into notches of the notched nut 38, by folding the tongues of the second lock washer 42 onto the yoke 4 and by screwing the second lock nut 43 against the third lock washer 44 pressed against the first end 3a of the connecting rod body 3.

Furthermore, for this exemplary embodiment, the circumferential shoulder 39 of the threaded rod 6 can comprise at least two flats on its outer surface, disposed at 180° with respect to one another. These flats allow the user to actuate, manually or using a tool, the threaded rod 6 for it to enter into rotation about the pivot axis A2. The tool can correspond to an open-end adjustable wrench, a monkey wrench, a combination wrench or any other kind of suitable tool.

The present invention relates also to a method for fitting the adjustable connecting rod 1 to a first element A and to a second element B (FIG. 3).

The method comprises the following steps:
a step E2 of alignment of the adjustable connecting rod 1 between the second element B and the first element A,
a step E3 of alignment of the yoke 4 in a desired angular position with respect to the first element A,
a step E4 of rotation of the intermediate part 5, 6 of the adjustment device 2 by a movement of the helical link L2.

The intermediate part 5, 6 is rotated with respect to the connecting rod body 3 by a user to drive a translation of the yoke 4 parallel to the pivot axis A2 until the yoke 4 reaches a desired position allowing the yoke 4 to be fixed to the first element A. The pivot link L1 is moved by the rotation of the intermediate part 5, 6 while the angular position of the yoke 4 is maintained.

The alignment step E2 corresponds to a placement of the adjustable connecting rod 1 between the two elements A and B such that the longitudinal axis A1 of the adjustable connecting rod 1 is as close as possible to its final position. Its final position corresponds to the position of the longitudinal axis A1 when the yoke 4 is fixed to the first element A.

The step E4 of alignment of the yoke 4 in a desired angular position about the pivot axis A2 corresponds to a final angular positioning of the yoke 4 corresponding to the angular position that the yoke 4 will have when it is fixed to the first element A.

The method further comprises a step E5 of fixing of the yoke 4 to the first element A.

According to the first configuration of the adjustable connecting rod 1, the method further comprises a step E1 of fixing of the second end 3b of the connecting rod body 3 to the second element B.

The method can further comprise a step E6 of locking by the locking device 7 to block the rotation of the intermediate part 5, 6 with respect to the connecting rod body 3 after the yoke 4 has reached a desired position allowing the yoke 4 to be fixed to the first element A.

According to exemplary embodiment, the step E6 can precede the step E5. In this variant, the locking device 7 blocks the rotation of the intermediate part 5, 6 before the yoke 4 is fixed to the first element A.

According to an exemplary embodiment, the step E6 can succeed the step E5. In this variant, the locking device 7 blocks the rotation of the intermediate part 5, 6 after the yoke 4 has been fixed to the first element A.

Such a connecting rod has the advantage of being interchangeable and of being able to be used for multiple applications requiring an adjustment.

While at least one exemplary embodiment is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A connecting rod that is adjustable in length extending along a longitudinal axis, comprising:
an adjustment device configured to adjust the length of the adjustable connecting rod and articulate the adjustable connecting rod to a first element,
a connecting rod body having a first end comprising the adjustment device and a second end configured to link the adjustable connecting rod to a second element,
wherein the adjustment device further comprises at least one fixing yoke configured to fix the adjustable connecting rod to the first element and an intermediate part linking the yoke to the connecting rod body between a pivot link and a helical link,
wherein the helical link is configured to allow a translation of the yoke along a pivot axis parallel to the longitudinal axis of the adjustable connecting rod when the intermediate part is rotated by a user about the pivot axis, and
wherein the pivot link is configured to allow an angular position of the yoke about the pivot axis to be maintained when the intermediate part is rotated about the pivot axis.

2. The connecting rod as claimed in claim 1, wherein the adjustment device further comprises a locking device configured to block the rotation of the intermediate part with respect to the connecting rod body after the yoke has reached a desired position allowing the yoke to be fixed to the first element.

3. The connecting rod as claimed in claim 1, wherein the pivot link links the intermediate part to the connecting rod body, and wherein the helical link links the intermediate part to the yoke.

4. The connecting rod as claimed in claim 3, wherein the yoke comprises a threaded rod having a longitudinal axis coinciding with the pivot axis,
wherein the intermediate part having a generally cylindrical form having an axis of revolution coinciding with the pivot axis,
wherein the intermediate part further having a tapped through-bore, the tapped through-bore having an axis of revolution coinciding with the pivot axis, the threaded rod of the yoke being screwed into the tapped through-bore of the intermediate part to form the helical link,
wherein the connecting rod body includes a smooth bore having an axis of revolution coinciding with the pivot axis, the smooth bore having a first end emerging on the first end of the connecting rod body,
wherein the intermediate part includes a smooth outer surface, the intermediate part is inserted into the smooth bore to form the pivot link,
wherein the adjustment device further comprises a blocking device configured to block the intermediate part in translation parallel to the pivot axis, and
a rotation of the intermediate part with respect to the connecting rod body by a user being able to drive a translation of the yoke along the pivot axis when the yoke is blocked in rotation about the pivot axis by the user.

5. The connecting rod as claimed in claim 1, wherein the pivot link links the intermediate part to the yoke, and
wherein the helical link links the intermediate part to the connecting rod body.

6. The connecting rod as claimed in claim 5, wherein the intermediate part corresponds to a threaded rod having an axis of revolution coinciding with the pivot axis,
wherein the yoke comprises an opening having a center coinciding with the pivot axis, the threaded rod having a first end passing into the opening of the yoke to form the pivot link,
the connecting rod body having a tapped bore having an axis of revolution coinciding with the pivot axis, the threaded rod having a second end screwed into the tapped bore to form the helical link,
the adjustment device further comprising a blocking device configured to block the yoke in translation parallel to the pivot axis along the threaded rod,
a rotation of the threaded rod with respect to the connecting rod body by a user being able to drive a translation of the threaded rod and of the yoke along the pivot axis when the yoke is blocked in rotation about the pivot axis by the user.

7. A method for fitting the adjustable connecting rod to a first element and to a second element as claimed in claim 1, comprising:
aligning the adjustable connecting rod between the second element and the first element,
aligning the yoke in a desired angular position about the pivot axis with respect to the first element,
rotating the intermediate part of the adjustment device by a movement of the helical link, the intermediate part being rotated with respect to the connecting rod body by a user to drive a translation of the yoke parallel to the pivot axis until the yoke reaches a desired position allowing the yoke to be fixed to the first element, the pivot link is moved by the rotation of the intermediate part while the angular position of the yoke is maintained, and
fixing the yoke to the first element.

8. The method as claimed in claim 7, further comprising fixing the second end of the connecting rod body to the second element.

9. The method as claimed in claim 7, further comprising locking by the locking device to block the rotation of the intermediate part with respect to the connecting rod body after the yoke has reached a desired position allowing the yoke to be fixed to the first element.
